(19) United States
(12) Patent Application Publication
(10) Pub. No.: US 2004/0013796 A1
(43) Pub. Date: Jan. 22, 2004

(54) Method of applying and maintaining a hard floor coating

(76) Inventor: Russell Metzger, Albuquerque, NM (US)

Correspondence Address: William J. McNichol, Jr., REED SMITH LLP, 2500 One Liberty Place, Philadelphia, PA, 19103-7301, US

(21) Appl. No.: 10/197,796

(22) Filed: Jul. 18, 2002

(51) Int. Cl. B05D 1/36

(52) U.S. Cl. 427/140; 427/407.1; 524/556

(57) ABSTRACT

The invention provides a method of applying and maintaining a hard floor coating. The method includes preparing the floor surface, sealing the floor surface, applying a colored polymer to the sealed surface, and applying a clear, non-epoxy floor finish. The invention can be used to change the color of an existing concrete or vinyl tile floor or it can be used to tint a floor, creating a uniform appearance on old vinyl tile or concrete floors. When a color change is desired or when the floor begins to look old, the top layers of finish can be removed, a colored polymer can be added, and a clear, non-epoxy finish can be applied. Thus, the floor color or design can be changed whenever it is desired. Color can be applied in virtually unlimited ways enabling the applicator to use creativity to achieve the desired result. In addition, a floor treated with the invention allows for easy repairs. In order to repair chips or scratches, the preparation step is performed, followed by application of at least one coat of a colored polymer to any chips or scratches which is then allowed to dry, followed by application of at least one coat of colored polymer over the entire surface area which is allowed to dry, followed by application of three or four coats of a clear, non-epoxy floor finish, followed by buffing the floor. The invention allows for a facility to keep its floors looking new without the long down-time or cost associated with replacing or stripping the existing floors.

### FIELD OF THE INVENTION

The present invention relates to coatings for hard floor coverings, and a method of applying and maintaining hard floor coatings.

### BACKGROUND

Various floor coverings are used in both residential and commercial settings. Concrete and vinyl tiles are two examples of common floor coverings. Generally, floor coverings need to be stripped, re-finished, and coated when the floor begins to look old or needs to be repaired. The cost of labor associated with stripping a floor is a major expense of floor care. It is also a time consuming process resulting in a period of time during which the floor can not be used.

Normally, the color or appearance of a floor can not be changed unless the existing floor is replaced. This can be a costly and time consuming procedure. Some floor coverings, however, are permanent and can not be removed. For example, concrete floors that have been treated with colored epoxies are permanent, making it impossible to change the color or appearance of the existing floor.

### SUMMARY OF THE INVENTION

The invention provides a method of applying a coating to hard floor coverings in a durable but non-permanent fashion. The method includes preparing the floor surface, sealing the floor surface, applying a colored polymer to the sealed surface, and applying a clear, non-epoxy floor finish. The method may be used on both concrete and vinyl tile floors and may be used to change the color of an existing floor or to provide a uniform color on an entire floor surface. When a color change is desired, the top layers of finish can be removed, a new colored polymer can be applied, followed by a clear, non-epoxy finish. Thus, the floor color or design can be changed as desired.

### DETAILED DESCRIPTION OF THE INVENTION

The present invention is directed to a method of applying a coating to hard floor coverings. The invention can be used to establish a uniform color on an old floor or can be used to change the floor color completely. It can be used on both concrete and vinyl tiles. A floor coated with the invention is extremely durable yet the coating may be removed if desired. Unlike floors finished with colored epoxies, a floor treated with the invention can be stripped or the color can be changed. However, the floor finish never needs to be stripped once the finish has been applied. Instead, when the floor begins to look old or if the owner wants to change the floor color, the floor can be top scrubbed, removing only the top layers of finish, followed by application of coats of colored polymer and several coats of a clear floor finish. Thus, the floor can be repaired or the color can be changed without stripping the floor all the way down to the bare surface. Another benefit of the present invention is that the cost of the coating is significantly less than the cost of vinyl tile replacement or concrete floors coated with epoxy. In addition, since a floor treated with the invention does not need to be stripped when repairs or a color change is made but only requires removal of the top layers of finish, the owner can also save the cost of labor associated with stripping the floor. An additional benefit of the present invention is the virtually unlimited number of designs that can be achieved. For example, the purchaser may choose a solid color, mixture of colors or may choose to create a pattern. Also, the floor may be tinted, creating a uniform apparent color over the entire surface, without changing the color of the underlying floor. This feature of the invention may be desirable in a multitude of areas such as in a commercial facility with old vinyl floors. If tiles have been replaced over the years with a similar but not identical color, tinting may be used to make all of the tiles look the same regardless of whether they are replacement tiles or the original tiles. An additional feature of the invention that sets it apart from other methods used to color a floor, such as Latex paint, is that the floor can be burnished with an ultra high speed floor machine which results in an extremely high gloss.

The invention comprises four steps. These are: surface preparation, sealing, application of a colored polymer, and application of a non-epoxy, clear floor finish.

In the preparation step, finish or seal is removed from the floor and the floor surface is cleaned. Preferably, a top scrub solution is applied to the floor, which is then buffed with a buffing machine. The floor is then wet/dry vacuumed. If necessary, this step can be repeated. The floor is then damp mopped with a neutral pH cleaner to remove any impurities that remain on the floor ensuring a dust-free and residue-free surface. A neutral pH cleaner works better than water alone to remove any existing residue that may be present on the floor.

After the floor surface has been prepared, the sealing step is performed. A sealer is a composition used to provide a uniform surface to which a colored polymer may adhere. It contains leveling agents which help the colored polymer to level out evenly on the floor surface. Various sealer compositions may be used and should be selected for their compatibility with the floor surface. The number of coats of sealer to be applied depends on the solids content of the sealer used. The higher the solids content, the fewer the number of coats that need to be applied. Application of a sufficient number of coats of sealer ensures an evenly and properly prepared surface to which a colored polymer can adhere. Two types of sealer may be preferably used in this step which are described below as Sealer Formula 1 and Sealer Formula 2.

Sealer Formula 1

Acrylic Copolymer Emulsion 10-20%

Diethylene Glycol Butyl Ether 3-5%

Diethylene Glycol Methyl Ether 1-3%

Tributoxyethyl Phosphate<1%

2,2-4-Trimethyl-1,3-Pentanediol Diisobutyrate 1-3%

Nonionic Surfactant<1%

5-Chloro-2-Methyl-4-Isothiazolin-3-One<0.1%

Water balance

Sealer Formula 1 is suited for application to concrete-type surfaces. Application of five coats of Sealer Formula 1 yields optimal results.

Sealer Formula 2

Diethylene Glycol Monoethyl Ether 3-5%

Tributoxyethyl Phosphate 1-3%

Potassium Floroalkyl Carbonates<1%

Styrene Acrylic Copolymer 10-15%

Styrene Acrylic Solution 1-3%

Propylene Glycol 1-3%

Polyolefin Emulsion 1-3%

Polyethylene Wax Emulsion 1-3%

5-Chloro-2-Methyl-4-Isothiazolin-3-One<0.1%

Water balance

Sealer Formula 2 is suited for application to softer surfaces, such as vinyl tile. Typically, six coats of Sealer Formula 2 are needed to achieve optimal results. Sealer Formula 2 requires more coats than Sealer Formula 1 because Sealer Formula 2 contains a lower solids content.

After a sealer is applied, it is cured, usually for twelve hours. A colored polymer can then be applied. Application of a colored polymer allows one to completely change the floor color or appearance, or simply add a tint to the floor, creating a uniform apparent color on the entire floor surface. Preferably, a colored polymer consists of a combination of a sealer and colorant. A colorant is a substance that imparts color to another material and can be either a pigment or a dye. Sealer is used because of its “rock” hard quality and low solids content which allows for the colorant to blend and level with the seal when it is applied to the floor. The same sealer formulas that are available for the sealing step are available for mixing with a colorant. The sealer that is used depends on the type of floor surface to which it will be applied. Sealer Formula 1 is generally mixed with a colorant and applied to concrete floors. Sealer Formula 2 is generally mixed with a colorant and applied to softer surfaces, such as vinyl tile.

As mentioned, the colorants in the colored polymer can be dye based or pigment based. There is no generally accepted distinction between dyes and pigments. However, dyes are usually soluble and used in solution to stain materials while pigments are generally insoluble and are used in suspension. The dyes used in this step contain a lower solids content than the pigments. Some colored polymers, especially those that contain a dye based colorant rather than a pigment, perform better when a coat or two of gray or white primer has been applied over the clear seal. Dye based colorants, for example, red, blue, yellow, and green, are not as effective as pigment based colorants in masking the underlying floor patterns, thus more coats are required. However, colorants that contain pigments usually achieve complete coverage of the floor without allowing any underlying patterns to come through. Therefore, colored polymers that contain dye based colorants achieve maximum results when a colored polymer containing a pigment based colorant, such as white or gray, is used as a primer before the desired color is applied.

A colored polymer varies in solid content depending on the color that is to be applied. Generally, the amount of solids range from 20% for a tint up to 28% for a solid color. If too much colorant is added to the sealer, the leveling agents found in the seal become overloaded and the color will not spread out evenly when applied to the sealed surface. However, this effect may be desired in some applications. For example, when the amount of solids approaches or exceeds 25%, areas of the floor may appear darker than other areas which creates an illusion of depth.

Before applying any color, a colored polymer can be cut and edged in around the perimeter of the prepared surface using foam or high quality hair paintbrushes to keep the color from contacting any surface other than the intended area of application. After the perimeter has been edged, a colored polymer is applied evenly to the surface. The application methods for a colored polymer, including the amount of color applied per coat or per square foot, depend on the desired effect. Also, a single color can be used, color can be mixed, or various colors or shades can be used to create designs. One method of application requires masking off the area of “non-contact,” for example, walls and baseboards, and using a sprayer, such as a pump-up sprayer or a paint gun, to apply the colored polymer. Generally, one to five light coats of colored polymer applied to concrete will allow some of the natural concrete patterns to come through. Each additional coat of colored polymer builds on the existing color base, thus minimizing this effect. Optimal results are achieved on concrete when eight to ten coats of colored polymer are applied. However, the applicator has discretion in the number of coats to be applied based on the desired effect.

Application of a colored polymer to vinyl tiles differs somewhat from concrete application. Generally, four or five coats of colored polymer are applied for a tint. When tinting, broken or cracked tiles should be replaced with tiles similar in color to the original color before beginning the process. When coloring, the color of the replacement tile is not important, especially if a primer is applied, since the tiles will be covered with a new color. When applying color, a minimum of five coats to a maximum of ten coats of colored polymer is usually applied. Generally, no more than five coats of colored polymer should be applied per day. The colored polymer should be allowed to cure, typically for 12-15 hours before application of color is resumed the next day. It is recommended that the area is buffed with a high speed buffer then dust and damp mopped before application of color is resumed. The colored polymer should then be allowed to cure, typically for 12-18 hours.

Finally, a clear, non-epoxy finish is applied. Buffing, dust mopping and damp mopping should be repeated before a clear floor finish is applied. The number of coats to be applied varies depending on the floor maintenance program of the facility. The type of buffers used and the frequency of buffing will determine the optimal number of coats to be applied. The number of coats also depends on the solids content of the finish. The higher the solids content of the finish, the fewer the number of coats that need to be applied. Several non-epoxy, clear floor finishes are available for this step, preferably Finishing Formulas 1, 2, and 3.

Finishing Formula 1

Diethylene Glycol Ethyl Ether 1-5%

Tributoxyethyl Phosphate 1-5%

Styrene/Acrylic Emulsion Polymer<20%

Polyethylene Wax Emulsion 1-10%

Water

It is recommended that Finishing Formula 1 be used in facilities that high-speed or ultra high-speed buff on a daily basis. Ten coats of Finishing Formula 1 yield optimal results.

Finishing Formula 2

Diethylene Glycol Ethyl Ether 1-5%

Tributoxyethyl Phosphate 1-5%

Styrene/Acrylic Emulsion Copolymer<20%

Polyethylene Wax Emulsion 1-5%

Water

Finishing Formula 2 is recommended for facilities that high-speed buff the floor several times per week. Twelve coats of Finishing Formula 2 are desired to achieve optimal results.

Finishing Formula 3

Diethylene Glycol Ethyl Ether 1-5%

Tributoxyethyl Phosphate 1-5%

Styrene/Acrylic Emulsion Copolymer<20%

Polyethylene Wax Emulsion 1-10%

Water

Finishing Formula 3 is a low-maintenance finish but responds well to high speed buffers. Eight coats are suggested for an optimal finish. This formula contains a higher solids content than either Finishing Formula 1 or 2 which is the reason it requires less coats.

In order to clean a floor treated by the method of this invention, it is recommended that a restorer solution, such as one containing at least Cocamide-DEA (1-10%), D-Limonene (1-10%), and water, be used either by mopping or in an automatic scrubber before high-speed buffing. Such a solution makes the floor less slippery, restores a deep shine to the finish, and cleans the floor. In addition, a neutral no-film cleaner is recommended for daily damp-mopping. A composition containing at least Tetrasodium E.D.T.A (1-5%), Nonionic surfactant (<10%), Sodium Lauriminodipropionate (1-5%), and water is recommended for this purpose.

If the colored polymer layer become scratched or chipped, this system also allows for easy repairs. The area to be repaired should be treated with a top scrub solution which can be applied using a foam brush. The area should then be buffed with a low speed machine, wet/dry vacuumed at least one time, then damp mopped with a neutral pH cleaner. A colored polymer should then be applied over any chips or scratches and should be allowed to dry and can be reapplied if necessary. A coat of the colored polymer should then be applied over the entire surface area. After the colored polymer has dried, three or four coats of a clear floor finish should be applied to the entire surface area. Finally, the surface should be buffed with a buffing machine. This repair procedure saves the facility the time associated with replacing a scratched or chipped floor and maintains a clean appearance.

What is claimed is:

1. A method of applying a coating to hard floor coverings in a non-permanent fashion comprising:
a) Preparing the floor surface
b) Sealing the floor surface
c) Applying a colored polymer to the sealed surface
d) Applying a clear, non-epoxy floor finish

2. The method of claim 1 wherein such hard floor covering is vinyl tile.

3. The method of claim 1 wherein such hard floor covering is concrete.

4. The method of claim 1 wherein the step of preparing the floor surface includes the following steps:
a) Cleansing the area with a floor buffer
b) Wet/dry vacuuming of the area
c) Damp mopping of the area with a neutral pH cleaner

5. The method of claim 1 wherein the surface is sealed by application of an acrylic copolymer.

6. The method of claim 5 wherein the surface is sealed by application of a composition comprising:
a) Acrylic Copolymer Emulsion 10-20%
b) Diethylene Glycol Butyl Ether 3-5%
c) Diethylene Glycol Methyl Ether 1-3%
d) Tributoxyethyl Phosphate<1%
e) 2,2-4-Trimethyl-1,3-Pentanediol Diisobutyrate 1-3%
f) Nonionic Surfactant<1%
g) 5-Chloro-2-Methyl-4-Isothiazolin-3-One<0.1%
h) Water

7. The method of claim 6 wherein said composition is applied to concrete.

8. The method of claim 1 wherein the surface is sealed by application of a styrene acrylic copolymer.

9. The method of claim 8 wherein the surface is sealed by application of a composition comprising:
a) Diethylene Glycol Monoethyl Ether 3-5%
b) Tributoxyethyl Phosphate 1-3%
c) Potassium Floroalkyl Carbonates<1%
d) Styrene Acrylic Copolymer 10-15%
e) Styrene Acrylic Solution 1-3%
f) Propylene Glycol 1-3%
g) Polyolefin Emulsion 1-3%
h) Polyethylene Wax Emulsion 1-3%
i) 5-Chloro-2-Methyl-4-Isothiazolin-3-One<0.1%
j) Water

10. The method of claim 9 wherein said composition is applied to vinyl tile.

11. The method of claim 1 wherein the sealing composition is allowed to cure for at least 12 hours before a colored polymer is applied.

12. The method of claim 1 wherein the colored polymer applied to the sealed surface comprises a colorant and sealer.

13. The method of claim 12 wherein the sealer contained in the colored polymer is an acrylic copolymer.

14. The method of claim 13 wherein the sealer contained in the colored polymer is a composition comprising:
a) Acrylic Copolymer Emulsion 10-20%
b) Diethylene Glycol Butyl Ether 3-5%
c) Diethylene Glycol Methyl Ether 1-3%
d) Tributoxyethyl Phosphate<1%
e) 2,2-4-Trimethyl-1,3-Pentanediol Diisobutyrate 1-3%
f) Nonionic Surfactant<1%
g) 5-Chloro-2-Methyl-4-Isothiazolin-3-One<0.1%
h) Water

15. The method of claim 14 wherein said composition is mixed with a colorant and applied to concrete.

16. The method of claim 12 wherein the sealer contained in the colored polymer is a styrene acrylic copolymer.

17. The method of claim 16 wherein the sealer contained in the colored polymer is a composition comprising:
a) Diethylene Glycol Monoethyl Ether 3-5%
b) Tributoxyethyl Phosphate 1-3%
c) Potassium Floroalkyl Carbonates<1%
d) Styrene Acrylic Copolymer 10-15%
e) Styrene Acrylic Solution 1-3%
f) Propylene Glycol 1-3%
g) Polyolefin Emulsion 1-3%
h) Polyethylene Wax Emulsion 1-3%
i) 5-Chloro-2-Methyl-4-Isothiazolin-3-One<0.1%
j) Water

18. The method of claim 17 wherein said composition is mixed with a colorant and applied to vinyl tile.

19. A composition applied to the sealed surface used to color or tint a floor comprising a colorant and a sealer.

20. The composition of claim 19 wherein the sealer contained in the colored polymer is an acrylic copolymer.

21. The composition of claim 20 wherein the sealer contained in the colored polymer is a composition comprising:
a) Acrylic Copolymer Emulsion 10-20%
b) Diethylene Glycol Butyl Ether 3-5%
c) Diethylene Glycol Methyl Ether 1-3%
d) Tributoxyethyl Phosphate<1%
e) 2,2-4-Trimethyl-1,3-Pentanediol Diisobutyrate 1-3%
f) Nonionic Surfactant<1%
g) 5-Chloro-2-Methyl-4-Isothiazolin-3-One<0.1%
h) Water

22. The composition of claim 21 wherein said composition is mixed with a colorant and applied to concrete.

23. The composition of claim 19 wherein the sealer contained in the colored polymer is a styrene acrylic copolymer.

24. The composition of claim 23 wherein the sealer contained in the colored polymer is a composition comprising:
a) Diethylene Glycol Monoethyl Ether 3-5%
b) Tributoxyethyl Phosphate 1-3%
c) Potassium Floroalkyl Carbonates<1%
d) Styrene Acrylic Copolymer 10-15%
e) Styrene Acrylic Solution 1-3%
f) Propylene Glycol 1-3%
g) Polyolefin Emulsion 1-3%
h) Polyethylene Wax Emulsion 1-3%
i) 5-Chloro-2-Methyl-4-Isothiazolin-3-One<0.1%
j) Water

25. The composition of claim 24 wherein said composition is mixed with a colorant and applied to vinyl tile.

26. The composition of claim 19 wherein the solids content of said composition ranges from 20% for a tint up to 28% for a solid color.

27. The method of claim 1 wherein the colored polymer is allowed to cure for at least 12-15 hours before application of a colored polymer is resumed the next day.

28. The method of claim 1 wherein the floor is buffed with a high speed buffer, dust mopped, and damp mopped after a colored polymer is applied, prior to commencing application of a colored polymer the next day.

29. The method of claim 1 wherein the final application of colored polymer is allowed to cure for 12-18 hours before the floor is buffed, dust mopped, and damp mopped.

30. The method of claim 1 wherein the clear, non-epoxy floor finish is a composition comprising a styrene acrylic emulsion copolymer.

31. The method of claim 30 wherein the clear, non-epoxy floor finish is a composition further comprising a polyethylene wax emulsion.

32. The method of claim 1 wherein the clear, non-epoxy floor finish is a composition comprising a styrene acrylic emulsion polymer.

33. The method of claim 32 wherein the clear, non-epoxy floor finish is a composition further comprising a polyethylene wax emulsion.

34. The method of claim 1 wherein the clear, non-epoxy floor finish is a composition comprising:
a) Diethylene Glycol Ethyl Ether 1-5%
b) Tributoxyethyl Phosphate 1-5%
c) Styrene/Acrylic Emulsion Polymer<20%
d) Polyethylene Wax Emulsion 1-10%
e) Water

35. The method of claim 1 wherein the clear, non-epoxy floor finish is a composition comprising:
a) Diethylene Glycol Ethyl Ether 1-5%
b) Tributoxyethyl Phosphate 1-5%
c) Styrene/Acrylic Emulsion Copolymer<20%
d) Polyethylene Wax Emulsion 1-5%
e) Water

36. The method of claim 1 wherein the clear, non-epoxy floor finish is a composition comprising:
a) Diethylene Glycol Ethyl Ether 1-5%
b) Tributoxyethyl Phosphate 1-5%
c) Styrene/Acrylic Emulsion Copolymer<20%
d) Polyethylene Wax Emulsion 1-10%
e) Water

37. A method of repairing the coating on vinyl tile or concrete floors treated with a colored polymer consisting essentially of:
a) Applying top scrub solution to the area to be repaired using a foam brush
b) Buffing the area with a low speed buffing machine
c) Wet/dry vacuuming the area at least one time
d) Damp mopping the floor with a neutral pH cleaner one time
e) Applying at least one coat of a colored polymer to any chips or scratches and allowing it to dry
f) Applying at least one coat of a colored polymer over the entire surface area and allowing it to dry
g) Reapplying 3 or 4 coats of a clear, non-epoxy floor finish
h) Buffing floor surface.
